(19) United States
(12) Patent Application Publication
(10) Pub. No.: US 2015/0213390 A1
(43) Pub. Date: Jul. 30, 2015

(54) Competitive Pricing Framework

(71) Applicant: Bank of America Corporation, Charlotte, NC (US)

(72) Inventors: James E. Rush, Charlotte, NC (US); Matthew Fragale, Matthews, NC (US); Andrew McGowan, Charlotte, NC (US); Joan O'Donoghue, Charlotte, NC (US); William Terrell, Lawrenceville, GA (US)

(73) Assignee: Bank of America Corporation, Charlotte, NC (US)

(21) Appl. No.: 14/230,746

(22) Filed: Mar. 31, 2014

Related U.S. Application Data
(60) Provisional application No. 61/932,594, filed on Jan. 28, 2014.

(51) Int. Cl. G06Q 10/06

(52) U.S. Cl. CPC G06Q 10/06393

(57) ABSTRACT

A framework for determining best in class pricing achievement for negotiated deals and underlying products and services is disclosed. An enterprise, such as a financial institution, may develop a list of industry standard pricing metrics for use when benchmarking or comparing similar products and services. The enterprise and competitive analysis firms may apply the scoring metrics to analyze negotiated deals and establish benchmarks of the deals to reach best in class. The deals may be reached using both internal and external analyses, and a deal score and executive summary template may be delivered to the enterprise at request.

### TECHNICAL FIELD

Aspects of the disclosure relate generally to developing and applying a competitive pricing framework. Specifically, aspects of the disclosure relate to a framework for determining best of class pricing achievement for negotiated deals and underlying products and services.

### BACKGROUND

Enterprises and other entities are often in deals with vendors, such as technology vendors, for various products and services. These enterprises are seeking to reach the best deal possible. In the past, these deals have generally been conducted only with analyses performed internally at the enterprise. If any external analysis was performed, it was generally very discrete and overly-broad in nature. As the sophistication of the deals, along with the underlying products and services, has increased, it has become more and more difficult to determine whether a negotiated deal can be considered a good deal or best in class among the enterprise's peers.

There is a need for a method of performing internal and external analyses that will identify specific areas of a deal that may be improved for an enterprise. There is also a need for a standard metric for scoring and analyzing negotiated deals.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Certain aspects disclose a method, comprising: receiving, at a processor, a key indicator, a scoring mechanism, and an executive summary template; receiving, at a processor, a negotiated deal, wherein the negotiated deal includes terms of the negotiated deal; calculating, at the processor, a deal score for the negotiated deal, wherein the deal score is calculated using the key indicator and the scoring mechanism; generating, at the processor, an executive summary, wherein the executive summary is generated using the executive summary template; and transmitting, at the processor, the deal score and the executive summary.

Certain other aspects disclose a non-transitory computer-readable storage medium having computer-executable program instructions stored thereon that, when executed by a processor, cause the processor to: receive a key indicator, a scoring mechanism, and an executive summary template; receive a negotiated deal, wherein the negotiated deal includes terms of the negotiated deal; calculate a deal score for the negotiated deal, wherein the deal score is calculated using the key indicator and the scoring mechanism; generate an executive summary, wherein the executive summary is generated using the executive summary template; and transmit the deal score and the executive summary.

Certain other aspects disclose an apparatus comprising: a memory; a processor, wherein the processor executes computer-executable program instructions which cause the processor to: receive a key indicator, a scoring mechanism, and an executive summary template; receive a negotiated deal, wherein the negotiated deal includes terms of the negotiated deal; calculate a deal score for the negotiated deal, wherein the deal score is calculated using the key indicator and the scoring mechanism; generate an executive summary, wherein the executive summary is generated using the executive summary template; and transmit the deal score and the executive summary.

The details of these and other embodiments of the disclosure are set forth in the accompanying drawings and description below. Other features and advantages of aspects of the disclosure will be apparent from the description, drawings, and claims.

### BRIEF DESCRIPTION OF THE DRAWINGS

All descriptions are exemplary and explanatory only and are not intended to restrict the disclosure, as claimed. The accompanying drawings, which are incorporated in and constitute a part of this specification, illustrate embodiments of the disclosure and, together with the description, serve to explain principles of the disclosure. In the drawings:

FIG. 1 shows an illustrative operating environment in which various aspects of the disclosure may be implemented.

FIG. 2 shows an illustrative block diagram of network devices and server that may be used to implement the processes and function of one or more aspects of the present disclosure.

FIG. 3 shows an illustrative flow chart in accordance with aspects of the disclosure.

FIG. 4 shows an illustrative deal score and scoring mechanism according to aspects of the disclosure.

FIG. 5 shows an illustrative executive summary template according to aspects of the disclosure.

FIG. 6 shows an illustrative competitive analysis construct according to aspects of the disclosure.

FIG. 7 shows an illustrative vendor dashboard according to aspects of the disclosure.

### DETAILED DESCRIPTION

In accordance with various aspects of the disclosure, methods, non-transitory computer-readable media, and apparatuses are disclosed for monitoring and outputting server inventory trends. In certain aspects, when a server receives a request data from a computing device, the server processes and analyzes the request and provides the requested data. The automated process may utilize various hardware components (e.g., processors, communication servers, memory devices, and the like) and related computer algorithms to generate image data related to the agency's business data.

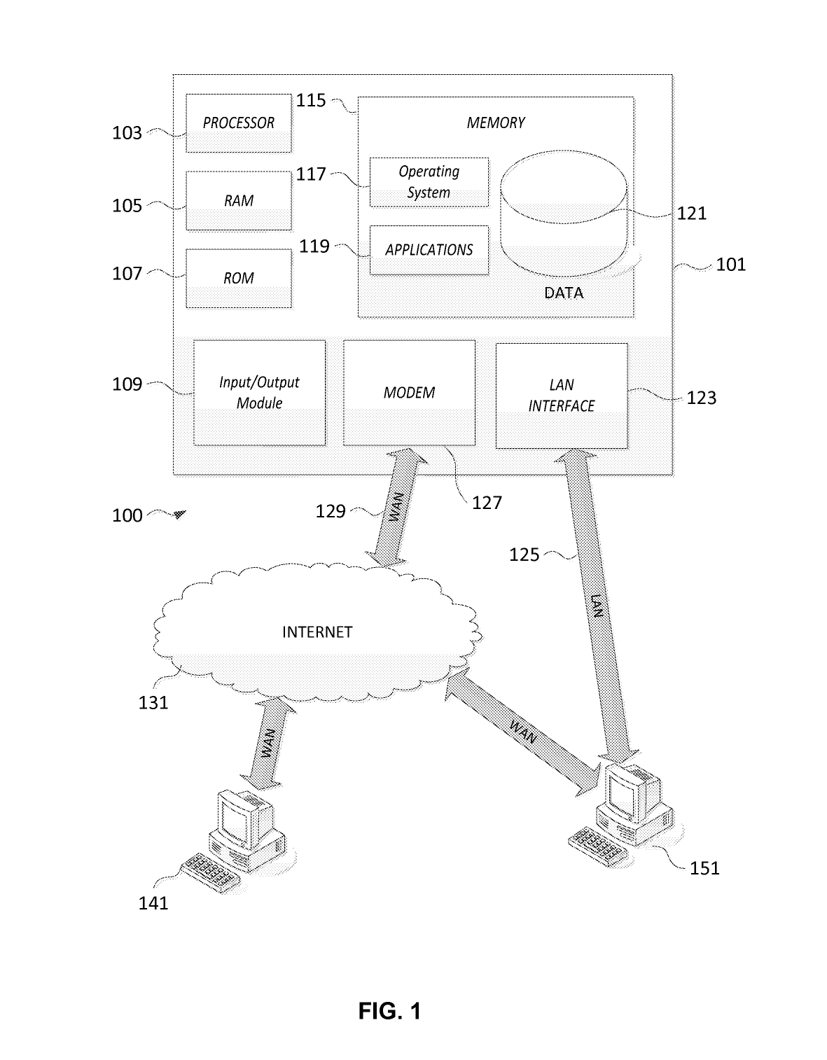

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

With reference to FIG. 1, the computing system environment 100 may include an enhanced computing server 101 wherein the processes discussed herein may be implemented. The enhanced computing server 101 may have a processor 103 for controlling the overall operation of the enhanced computing server 101 and its associated components, including random-access memory (RAM) 105, read-only memory (ROM) 107, communications module 109, and memory 115. Processor 103 and its associated components may allow the enhanced computing server 101 to run a series of computer-readable instructions related to receiving, storing, and analyzing data.

Enhanced computing server 101 typically includes a variety of computer-readable media. Computer-readable media may be any available media that may be accessed by enhanced computing server 101 and include both volatile and non-volatile media, removable and non-removable media. For example, computer-readable media may comprise a combination of computer storage media and communication media.

Computer storage media include volatile and non-volatile, removable and non-removable media implemented in any method or technology for storage of information such as computer-readable instructions, data structures, program modules, or other data. Computer storage media include, but are not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information that can be accessed by enhanced computing server 101.

Computing system environment 100 may also include optical scanners (not shown). Exemplary usages include scanning and converting paper documents, such as correspondence, data, and the like to digital files.

Although not shown, RAM 105 may include one or more applications representing the application data stored in RAM 105 while the enhanced computing server 101 is on and corresponding software applications (e.g., software tasks) are running on the enhanced computing server 101.

Communications module 109 may include a microphone, keypad, touch screen, and/or stylus through which a user of enhanced computing server 101 may provide input, and may also include one or more of a speaker for providing audio output and a video display device for providing textual, audiovisual and/or graphical output.

Software may be stored within memory 115 and/or storage to provide instructions to processor 103 for enabling enhanced computing server 101 to perform various functions. For example, memory 115 may store software used by the enhanced computing server 101, such as an operating system 117, application programs 119, and an associated database 121. In certain aspects, enhanced computing server 101 may comprise a plurality of databases 121. Also, some or all of the computer executable instructions for enhanced computing server 101 may be embodied in hardware or firmware.

Enhanced computing server 101 may operate in a networked environment supporting connections to one or more remote computing devices, such as computing devices 141 and 151. The computing devices 141 and 151 may be personal computing devices or servers that include many or all of the elements described above relative to the enhanced computing server 101.

The network connections depicted in FIG. 1 include a local area network (LAN) 125 and a wide area network (WAN) 129, but may also include other networks. When used in a LAN networking environment, enhanced computing server 101 may be connected to the LAN 125 through a network interface or adapter in the communications module 109. When used in a WAN networking environment, the enhanced computing server 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system may be operated in a client-server configuration to permit a user to retrieve web pages from a web-based server. Any of various conventional web browsers may be used to display and manipulate web pages.

Additionally, one or more application programs 119 used by the enhanced computing server 101, according to an illustrative embodiment, may include computer executable instructions for invoking functionality related to communication including, for example, email short message service (SMS), and voice input and speech recognition applications. In addition, the application programs 119 may include computer executable instructions for invoking user functionality related to access a centralized repository for performing various service tasks like routing, logging, and protocol bridging.

Embodiments of the disclosure may include forms of computer-readable media. Computer-readable media include any available media that can be accessed by an enhanced computing server 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For instance, aspects of the method steps disclosed herein may be executed on a processor 103 on enhanced computing server 101. Such a processor may execute computer-executable instructions stored on a computer-readable medium.

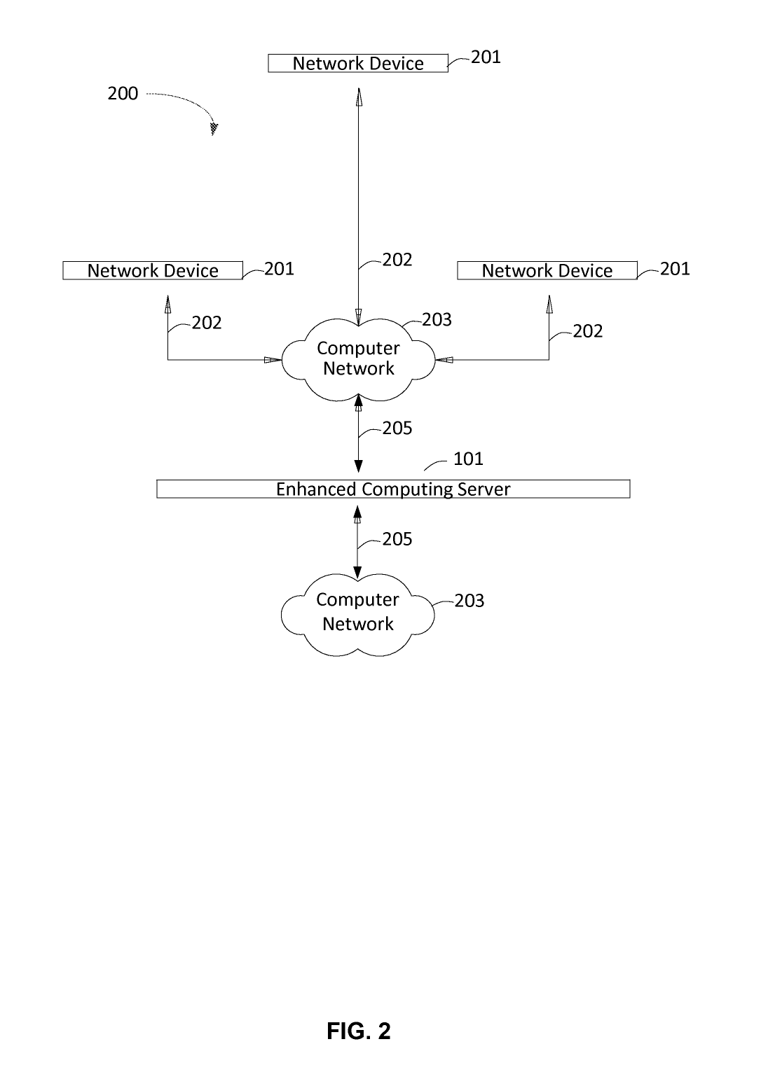

FIG. 2 illustrates another example operating environment in which various aspects of the disclosure may be implemented. As illustrated, system 200 may include one or more network devices 201. Network devices 201 may, in some examples, be connected by one or more communications links 202 to computer network 203 that may be linked via communications links 205 to server 204. In system 200, server 204 may be any suitable server, processor, computer, or data processing device, or combination of the same. Server 204 may be used to process the instructions received from, and the transactions entered into by, one or more participants.

According to one or more aspects, system 200 may be associated with a financial institution, such as a bank. Various elements may be located within the financial institution and/or may be located remotely from the financial institution. For instance, one or more network devices 201 may be located within a branch office of a financial institution. Such network devices may be used, for example, by customer service representatives, other employees, and/or customers of the financial institution in conducting financial transactions via network 203. Additionally or alternatively, one or more network devices 201 may be located at a user location (e.g., a customer's home or office). Such network devices also may be used, for example, by customers of the financial institution in conducting financial transactions via computer network 203. In some aspects, network devices 201 a server such as enhanced computing server 101. Enhanced computing server 101 may be located at an entity such as a competitive analysis firm and network device 201 may be located at a financial institution.

Computer network 203 may be any suitable computer network including the Internet, an intranet, a wide-area network (WAN), a local-area network (LAN), a wireless network, a digital subscriber line (DSL) network, a frame relay network, and asynchronous transfer mode network, a virtual private network (VPN), or any combination of any of the same. Communications links 202 and 205 may be any communications links suitable for communicating between network devices 201 and server 204, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

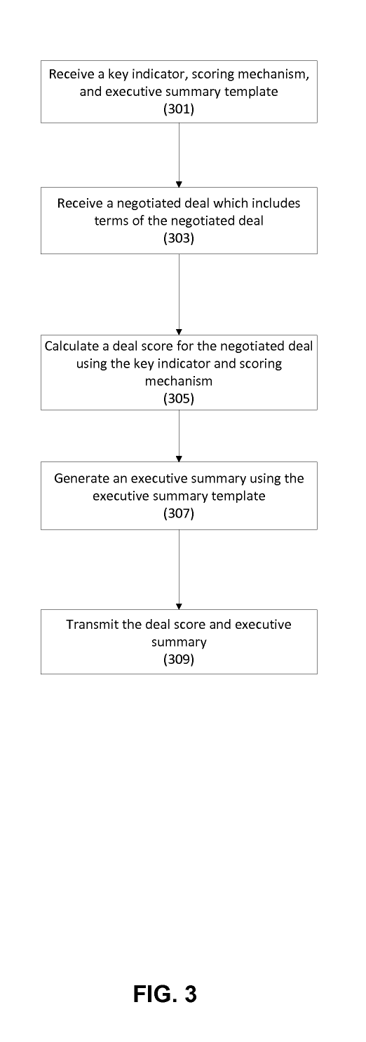

FIG. 3 shows an exemplary flow chart according to certain aspects of the disclosure. The process shown in FIG. 3 may begin when enhanced computing server 101 receives a key indicator, scoring mechanism, and executive summary template. The enhanced computing server 101 may be located at and managed by a competitive analysis firm. The competitive analysis firm may be in communication with an enterprise, such as a financial institution. In certain aspects, the financial institution may communicate with the competitive analysis via network device 201. Network device 201 may comprise a server such as enhanced computing server 101. As shown in FIG. 2, the competitive analysis firm may be external from the financial institution.

Often, the financial institution may negotiate one or more deals with vendors, such as technology vendors. The deals may be for products, such as computers and software, and may be for services, such as network access and software maintenance. The financial institution may perform due diligence prior to coming to terms for a negotiated deal with the vendor. According to aspects of the disclosure, the financial institution may perform an internal analysis and external analysis, for example via a processor 103. The internal analysis may be performed at the financial institution and the external analysis may be performed by a third-party, such as a competitive analysis firm. The external analysis firm may perform, for example at enhanced computing server 101, an analysis of a proposed or negotiated deal to provide the financial institution with requested feedback. In order to perform the external analysis and to provide the requested feedback, the financial institution may transmit at least one of a key indicator, scoring mechanism, and executive summary template which may be received at the competitive analysis firm's enhanced computing server 101.

The key indicator may comprise standard pricing metrics that may be used when benchmarking or comparing similar information technology (IT) products and services. In other words, the key indicator may indicate the standard pricing unit used by the financial institution to compare vendor products and services to competitors of the financial institution and the industry as a whole. The financial institution may transmit the key indicator to the competitive analysis firm (via communication link 202, for example) at step 301 so that the competitive analysis firm may be able to compare the pricing of the financial institutions negotiated deal with the pricing of similar deals made by competitors. A negotiated deal may refer to a deal for a product or service made by an enterprise with a vendor. A negotiated deal may also refer to a deal being considered by an enterprise with a vendor. For example, a financial institution may enter a negotiated deal with a technology vendor to purchase 100 desktops. In another example, a financial institution may be considering entering a deal with a technology vendor, which may also be referred to herein as a negotiated deal.

The key indicator may be received at enhanced computing server 101 located at the competitive analysis firm. The key indicator may comprise a plurality of pricing guidelines. An exemplary key indicator is shown in the Table 1 below:

TABLE 1

| Product/ | | | | |
|---|---|---|---|---|
| Service | Standard Pricing Metrics | | | |
| Network | Price per | | | |
| | port | | | |
| Storage | Discount % | $/TB by Tier | $/TB by | Year to year |
| | | | drive type | decline |
| Servers | Discount % | Year to year | Price per | Price per |
| | | processor | processor | core |
| | | power | | |
| | | improvement | | |
| | | for similar $$ | | |
| Software | Discount % | Price per user | Price per | Price per |
| | | | license | processor |
| Maintenance | Price per | Price per unit | Price per | |
| | license | | user | |
| Desktop | Price per | List price | Price per | |
| | unit | discount | component | |
| Laptop | Price per | List price | Price per | |
| | component | discount | component | |

As shown in Table 1, the key indicator may identify one or more standard pricing metrics for each product and service. A competitive analysis firm may receive the key indicator above at enhanced computing server 101. The key indicator may be stored at memory 115. As discussed in detail below, the key indicator may be used to analyze a negotiated deal and to calculate a deal score for a negotiated deal.

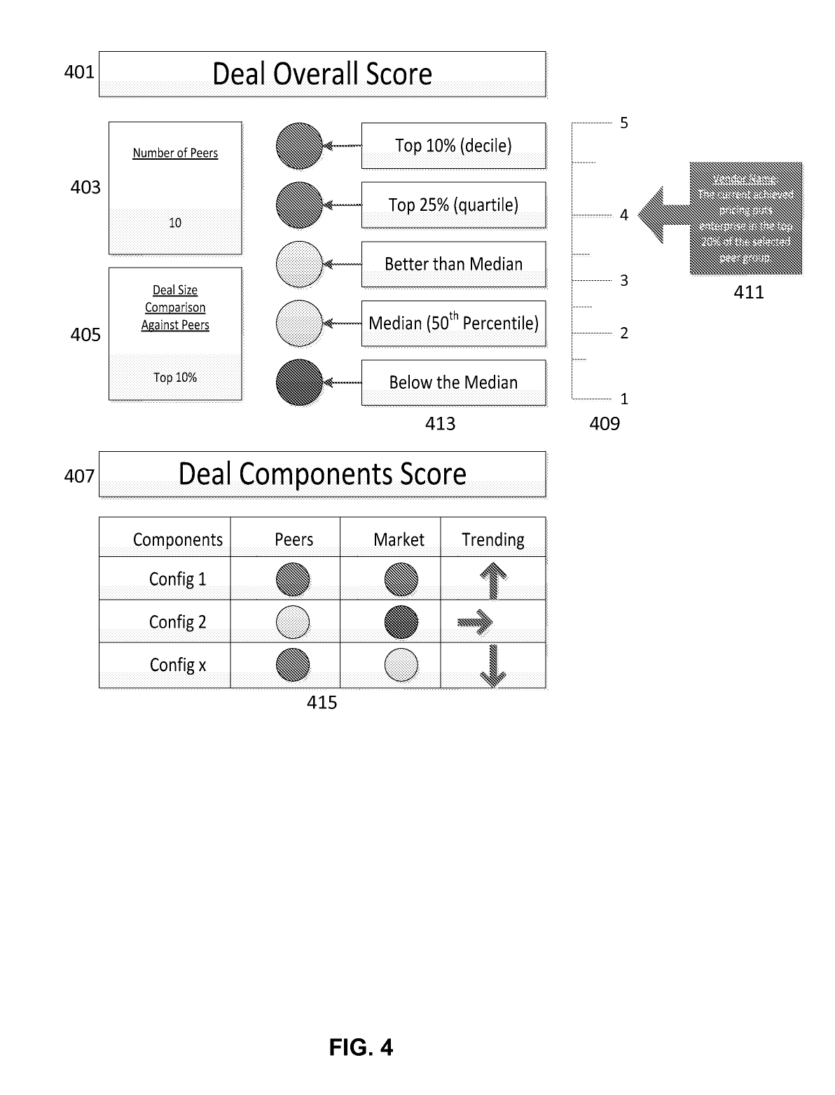

At step 301, enhanced computing server 101 may also receive a scoring mechanism. An exemplary scoring mechanism is illustrated in FIG. 4. The scoring mechanism may be transmitted from an enterprise to a competitive analysis firm to provide the competitive analysis firm with an understanding of the scoring system to be used when evaluating the financial institutions one or more negotiated deals. The scoring mechanism may also serve as a template of deliverables that the financial institution expects in return after the competitive analysis firm completes its analysis of the one or more negotiated deals.

According to aspects of the disclosure, the scoring mechanism received at the competitive analysis firm may comprise a division of deal score percentiles. For example, as shown in FIG. 4, the scoring mechanism may comprise five distinct classifications based on the deal score percentile. The highest classification may be the top 10% or top decile, followed by the top 25% or top quartile, followed by better than median, followed by median or 50th percentile, and concluding with below the median. Each of the percentile classifications may be based in comparison with peers of the enterprise that have negotiated a deal. For example, if the enterprise is a large bank, the comparisons may be made with respect to other large banks that have negotiated deals for similar products and services. If Bank A has entered a negotiated deal with a technology vendor for a desktop, for instance, top quartile scoring may indicate that the negotiated deal is in the top 25% of deals among Bank A peers for desktop deals with technology vendors.

Each score classification may be color coded to be associated with a particular color. Top decile and top quartile may be color coded green. Better than median and median scoring may be color coded yellow, and below median scoring may be color coded red. Each of these color coded schemes may be used to represent the strength of a negotiated deal. For example, according to aspects of the disclosure, top quartile scoring and above (including top decile scoring) may be considered “best in class.” Thus, the green color coding may indicate that a deal is best in class. Deals scored between the 25th and 50th percentiles may be considered an average or mediocre deal based on the peer group, so the yellow color coding may indicate an average deal. It should be noted that the median may be used rather than the average score to determine an average deal because the median may be a better predictor of central tendency and reduces the top and bottom score outliers. Finally, scores below the median may be considered a deal that could use improvement for the enterprise, so below the median deals may be color coded red.

The scoring mechanism may also comprise a numerical score. The numerical score may correspond with the percentile classification described above. An exemplary numerical scale 409 that may correspond to the percentile classifications 413 is shown in FIG. 4. The numerical scale 409 may comprise a range of numerical scores. In the example provided in FIG. 4, the numerical scores of numerical scale 409 may range between 1 and 5. The numerical scores may be calculated at the competitive analysis firm (via processor 103, for example). In some aspects, the scoring mechanism may comprise a rubric for associating a numerical score with the corresponding percentile classification. In some other aspects, the competitive analysis firm may perform the association itself at enhanced computing server 101. As an example, numerical scores ranging from 3.5-5 may be considered best in class; numerical scores ranging from 1.5-3.5 may be considered average; and numerical scores ranging from 1-1.5 may be considered in need of improvement.

The scoring mechanism may comprise a plurality of variables to be used by the competitive analysis firm in calculating numerical scores and, in some aspects, the percentile classifications. The variables may comprise at least one of headline discounts, concessions, vendor history, product type, quantities purchased, negotiation leverage, and deal flexibility. Headline discounts may refer to discounts or saves received by an enterprise from a vendor, such as a technology vendor. For example, a financial institution may enter a negotiated deal with a technology vendor to purchase a desktop priced at $1,000. The vendor may ultimately sell the desktop to the financial institution for $900. Thus, the headline discount in this example may be $100.

Concessions may refer to additional benefits provided by the technology vendor. For example, the technology vendor may sell a desktop at the original list price of $1,000, but may offer a concession of charging software fees at price per user, rather than price per device. Price per user charges may be cheaper for the financial institution than price per license charges, and may thus be an additional benefit received from the technology vendor. Vendor history may refer to the relationship history between the financial institution and the technology vendor. In some aspects, maintaining a long vendor history may lead to further discounts for future negotiated deals. Product type may refer to the type of product or service exchanged in the negotiated deal. For example, the product type may be services, hardware, software, and the like. Quantities purchased may refer to the number of units purchased in the negotiated deal. Negotiation leverage may refer to the ability to walk away from the negotiated deal and negotiate with alternative vendors. Finally, deal flexibility may refer to the flexibility of the terms of the negotiated deal. In other words, deal flexibility may refer to the ease with which terms of the negotiated deal may be modified, canceled, or added.

In addition to the variable discussed above, the scoring mechanism may also comprise instructions or requests for providing the number of peers 403, size comparison 405, and comments 411. Number of peers 403 may comprise a section of the scoring mechanism in which the competitive analysis firm may input the number of peers being evaluated for the negotiated deal. Size comparison 405 may comprise a deal size comparison of the negotiated deal against the enterprise's peer group. The deal size may be represented by the competitive analysis firm as a percentile range, such as the top 10%, top 25%, and the like. Comments 411 may comprise a portion of the scoring mechanism in which the competitive analysis firm may input comments evaluating the negotiated deal. As shown in FIG. 4, comments 411 may also comprise an arrow indicating the numerical score of the negotiated deal.

The scoring mechanism received by enhanced computing server 101 at step 301 may also comprise instructions for completing a components table 415. The components table 415 may comprise an indication of each configuration's negotiated deal score as compared with peers and the market, and an indication of which direction each configuration's deal score is trending. Configurations may be generally considered components and may refer to the various aspects of a product or service included in a negotiated deal. Returning to the desktop negotiated deal example, the negotiated desktop may comprise numerous configurations, including software components, memory components, CPU components, maintenance components, and the like. The scoring mechanism may include instructions to compare each component with similar components negotiated in the enterprise's peer group as discussed above. The scoring mechanism may also include instructions to compare each component with similar components negotiated in the market. In some aspects, the market may comprise all businesses in the same industry. For example, if the enterprise is a financial institution, the market may refer to all financial institutions in a specified geographic location, such as country, world, and the like. Market may also refer to all businesses across all industries in some aspects.

The trending column shown in components table 415 may refer to the trend of prices and/or negotiated deals of a corresponding configuration. The scoring mechanism may include instructions for providing the trending information. For example, if the price of a configuration is trending upwards over a particular time period, the corresponding trending column may include an arrow pointed up. If the price of a configuration is trending downwards over a particular time period, the corresponding trending column may include an arrow pointed down.

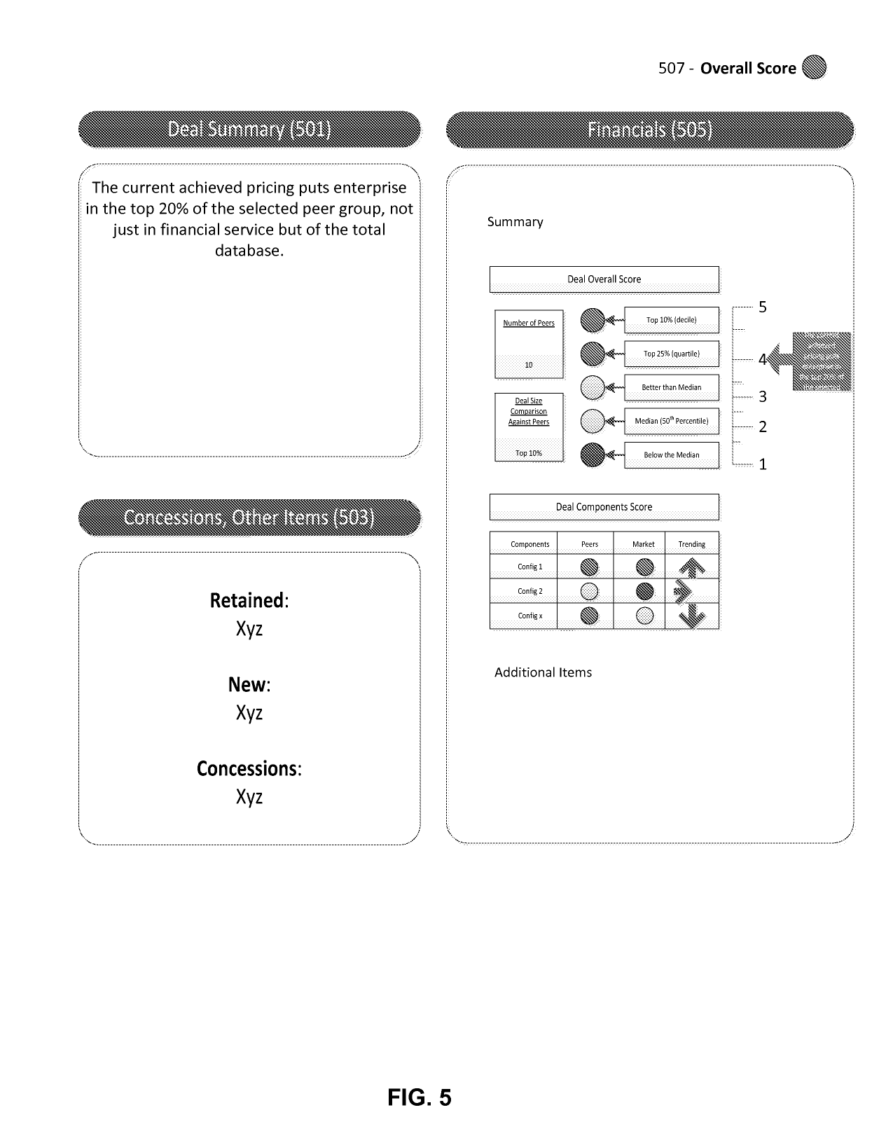

In addition to the key indicator and scoring mechanism, enhanced computing server 101 may also receive an executive summary template at step 301. The executive summary template may provide the competitive analysis firm with another example of deliverables expected. Thus, an enterprise, such as a financial institution, may transmit an executive summary template to a competitive analysis firm at step 301. An exemplary executive summary template is shown in FIG. 5. The executive summary template may comprise a deal summary section 501, concessions section 503, financials section 505, and overall score 507. The executive summary template may also comprise instructions for completing an executive summary. The instructions may indicate that deal summary section 501 should be completed by the competitive analysis firm to summarize a negotiated deal specified to the competitive analysis firm. The instructions may also explain that concessions section 503 should be completed by the competitive analysis firm to provide a description of the concessions provided in a specified negotiated deal. Moreover, concessions section 503 may also comprise other items such as the products and services retained in a negotiated deal and new products and services gained in a negotiated deal.

The executive summary template may also comprise a financials section 505, which may be used to provide a summary of the financials of a negotiated deal. The summary may comprise a deal overall score and deal components score, along with other data calculated by the competitive analysis firm using the scoring mechanism. The executive summary template may also comprise an overall score 507. In certain aspects, the competitive analysis firm may be instructed by a financial institution to provide an overall score indication at overall score 507. The overall score indication may be color coded as discussed above, such that green indicates a best in class negotiated deal, yellow indicates an average negotiated deal, and red indicates a negotiated deal that needs improvement. A competitive analysis firm may receive the executive summary template via enhanced computing server 101 and store the executive summary template, along with the key indicator and scoring mechanism, at memory 115.

At step 303, enhanced computing server 101 may receive a negotiated deal which includes terms of the negotiated deal. Step 303 may occur at some time after step 301, at the same time as step 301, or before step 301 in some aspects. In certain aspects, step 303 may occur even without step 301. However, as shown in exemplary FIG. 3 and discussed herein, step 303 may occur after step 301.

An enterprise, such as a financial institution, may transmit the negotiated deal to the competitive analysis firm (via communication link 202, for example). The negotiated deal may comprise a deal for a product or service between the financial institution and a technology vendor. According to aspects of the disclosure, a negotiated deal may be reached after the financial institution performs a combination of internal analysis and external analysis. In other words, a negotiated deal may comprise terms of a deal that were negotiated using a combination of internal analysis and external analysis. An example is provided below detailing the analyses that may be performed for a negotiated deal between Bank A (the enterprise) and Vendor B (the technology vendor) for Desktop C (the negotiated product) using Firm D (the competitive analysis firm).

Internal analysis may refer to the analysis performed at the enterprise. Bank A may perform its own due diligence prior to or during negotiation of terms for Desktop C. This due diligence may comprise reviewing historical pricing and concessions for desktops such as Desktop C. The historical pricing and concessions may be stored in a database such as database 121 located at Bank A. The internal research and analysis may be performed at Bank A via a processor such as processor 103. The internal analysis may also comprise reviewing internal and external subject-matter expert (SME) knowledge, performing industry research at Bank A, and reviewing previous external analyses. The previous external analyses may comprise analyses of previous Bank A negotiated deals for Desktop C and other similar desktops.

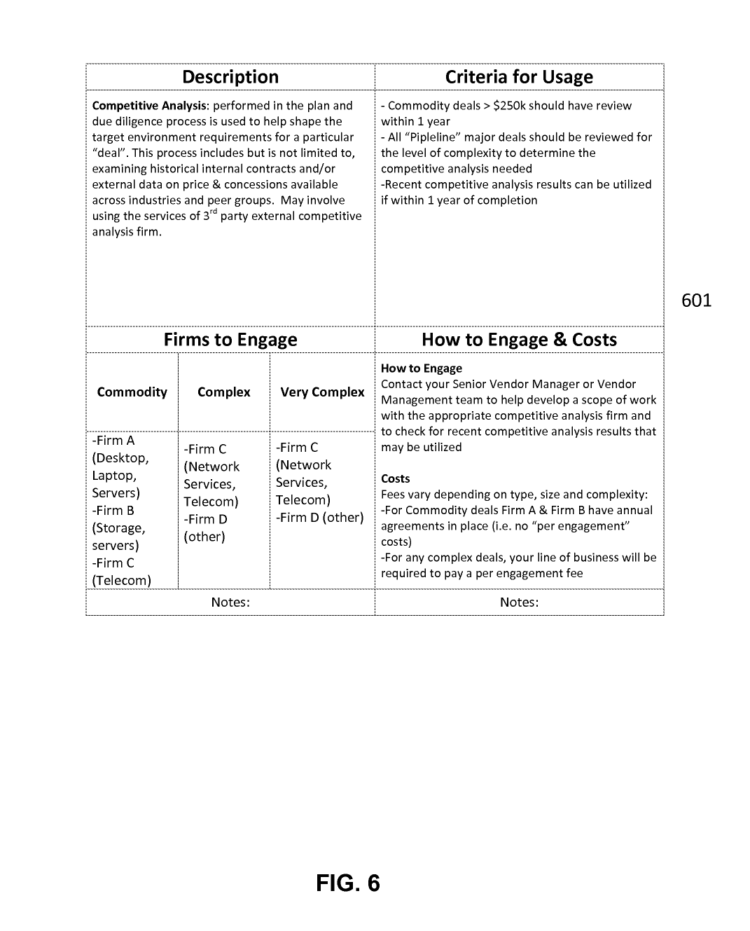

The internal analysis process may take days or weeks for Bank A to complete. Thereafter, Bank A may determine whether further, external analysis is needed. If Bank A determines that external analysis is needed, Bank A may provide internal guidelines 601, as shown in FIG. 6, to Bank A employees that may engaged the external analysis firms. The internal guidelines 601 may be transmitted from a server such as enhanced server 101 to the employee computer devices 141 and 151 where they are displayed to the employees. The internal guidelines 601 may comprise a description of competitive analysis and what the Bank A employees may expect in the interaction with Firm D. Internal guidelines 601 may also comprise criteria for usage, explaining when and how to use the external competitive analysis firm, along with a section explaining how to engage the competitive analysis firm and typical costs. Moreover, internal guidelines 601 may comprise a list of firms to engage for deals of various complexities. Internal guidelines 601 may comprise other sections, such as a section for notes and the like.

After reviewing internal guidelines 601, Bank A may determine the appropriate level of external analysis required for the negotiated deal. The external analysis may comprise at least one of Level 1 external analysis, Level 2 external analysis, and Level 3 external analysis.

Level 1 external analysis may comprise a limited commodity pricing service. The Level 1 external analysis provided by Firm D may comprise directional knowledge and specifics on pricing. For instance, Bank A may call or communicate via communication link 202 with Firm D, informing Firm D that Bank A may be able to purchase Desktop C for $1,000. Bank A may ask whether that would be considered top quartile pricing by Firm D. Firm D may then perform a Level 1 external analysis at processor 103 and inform Bank A whether $1,000 for Desktop C is top quartile pricing, and if not, identify the price point Bank A would need to reach to hit top quartile pricing. For instance, Firm D may notify Bank A that $1,000 for Desktop C is not top quartile pricing, but $900 would be top quartile pricing. Thus, market analysis and comparison with the enterprise's peer group may be the key deliverable under Level 1 external analysis.

Level 2 external analysis may comprise the analysis performed at Level 1 plus additional strategic analysis that may be beneficial to the enterprise. Level 2 external analysis may comprise Firm D providing specific, detailed knowledge on pricing and strategy. Staying with the example provided above, Firm D may perform the same analysis discussed for the Level 1 external analysis. In addition, Firm D's Level 2 external analysis may comprise analyzing and providing a strategy to Bank A for achieving the desired top quartile pricing. For example, Firm D may provide strategies for negotiating the price of Desktop C from $1,000 to $900. Firm D may also notify Bank A of concessions that Vendor B may likely offer and how to obtain those concessions. Level 2 external analysis may also comprise analyzing and providing other cost cutting suggestions, such as negotiating per user deals rather than per license deals, and the like. Level 2 external analysis, therefore, may include technical, vendor, market, and strategic considerations that may not be offered under a Level 1 external analysis.

Likewise, a Level 3 external analysis may provide Bank A with beneficial services beyond those offered by a Level 2 external analysis. Under a Level 3 external analysis, Firm D, in addition to the services provided under a Level 2 external analysis, may also aid Bank A in structuring a negotiated deal. Bank A may undergo a Level 3 external analysis for highly complex negotiated deals. Whereas the deal for a single Desktop C may only require a Level 1 or Level 2 analysis, a deal with Vendor B with hundreds or thousands of products and services may require a higher level of external analysis. A Level 3 external analysis may comprise focusing on commercial terms and the full circumstantial/historic relationship with Vendor B. Moreover, Firm D may provide a greater level of assistance and accessibility for Bank A under a Level 3 external analysis. Firm D may communicate via communication link 202 with Bank A and be available to discuss the negotiated deal at any time of the day. Moreover, Firm D may be on-site with Bank A when the negotiated deal is structured. This level of accessibility may exceed the level of communication between Bank A and Firm D via Level 1 and Level 2 external analyses, which may typically be conducted with short phone calls or via the Internet. Furthermore, Level 1 and Level 2 external analyses may typically span several days to weeks, whereas Level 3 external analyses may typically span several weeks to months.

After receiving a negotiated deal at step 303, enhanced computing server 101 may calculate a deal score for the negotiated deal using the key indicator and scoring mechanism at step 305. The deal score may be calculated by the competitive analysis firm during the external analysis. In some aspects, the deal score may be calculated after the external analysis. Returning to the Level 1 external analysis example, Bank A may be in negotiations with Vendor B for Desktop C. Vendor B may offer the Desktop to Bank A for $1,000. Bank A may perform an internal analysis to determine whether the $1,000 offer, also referred to herein as a negotiated deal, is satisfactory. Thereafter, Bank A may determine that a Level 1 external analysis should be performed by Firm D. Bank A may ask if $1,000 is a top quartile deal score. Firm D may receive the terms of the negotiated deal at step 303, and then calculate a deal score at step 305.

The deal score may be calculated using the key indicator and scoring mechanism, as discussed previously. The deal score may comprise a deal overall score 401 and a deal components score 407. Processor 103 at enhanced computing server 101 may analyze the key indicator, shown in Table 1, above. Processor 103 may determine, using the key indicator, that the pricing metric used for the desktop is price per unit. Processor 103 may then analyze the component variables, which may comprise one or more of headline discounts, concessions, vendor history, product type, quantities purchased, negotiation leverage, and deal flexibility. Firm D may use processor 103 to analyze each of the variables for each component of Desktop C.

Enhanced computing server 101 may then compare the negotiated deal by component with other similar deals performed by peers of Bank A and the market as a whole. Processor 103 may also analyze the trend of prices for each component as discussed above. Next, processor 103 may generate a complete components table 415 for Desktop C, including color coded indications of the strength of each deal.

Processor 103 may also calculate a numerical score for the negotiated deal. For example, processor 103 may calculate a numerical score of 4 out 5 for the Desktop C offer at $1,000. Processor 103 may calculate the score based on metrics and grading rubrics stored at memory 115, and also based on comparisons with negotiated deals of peers and the market. As shown in FIG. 4, an indication may be included at comments 411, along with comments about the negotiated deal, generated at processor 103. Enhanced computing server 101 may also input at number of peers 403 the number of Bank A peers compared to generate the deal score (10 peers in exemplary FIG. 4). At size comparison 405, enhanced computing server 101 may also calculate and input the size of the negotiated deal as compared with Bank A peers (Top 10% in exemplary FIG. 4). The numerical score highlighted in numerical scale 409 may correspond with the percentile classification 411 according to a grading rubric stored at memory 115. Thus, using the key indicator and scoring mechanism, processor 103 may calculate a deal score for the negotiated deal that may comprise a deal overall score 401 and a deal components score 407.

After step 305, processor 103 may generate an executive summary using an executive summary template stored at memory 115 at step 307. The template shown in FIG. 5 may be populated with data calculated at step 305. Moreover, processor 103 may provide, or a user may input, additional details at deal summary 501, concessions 503, and financials 505. For example, processor 103 may populate deal summary 501 with a summary of the negotiated deal between Bank A and Vendor B for Desktop C at $1,000. Processor 103 may also populate concessions 503 with pertinent information about the negotiated deal, such as concessions and other variables. Processor 103 may populate the financial 505 with the financial data calculated at step 305, such as the deal overall score and the deal components score. An overall score color coded indication may also be provided at overall score 507.

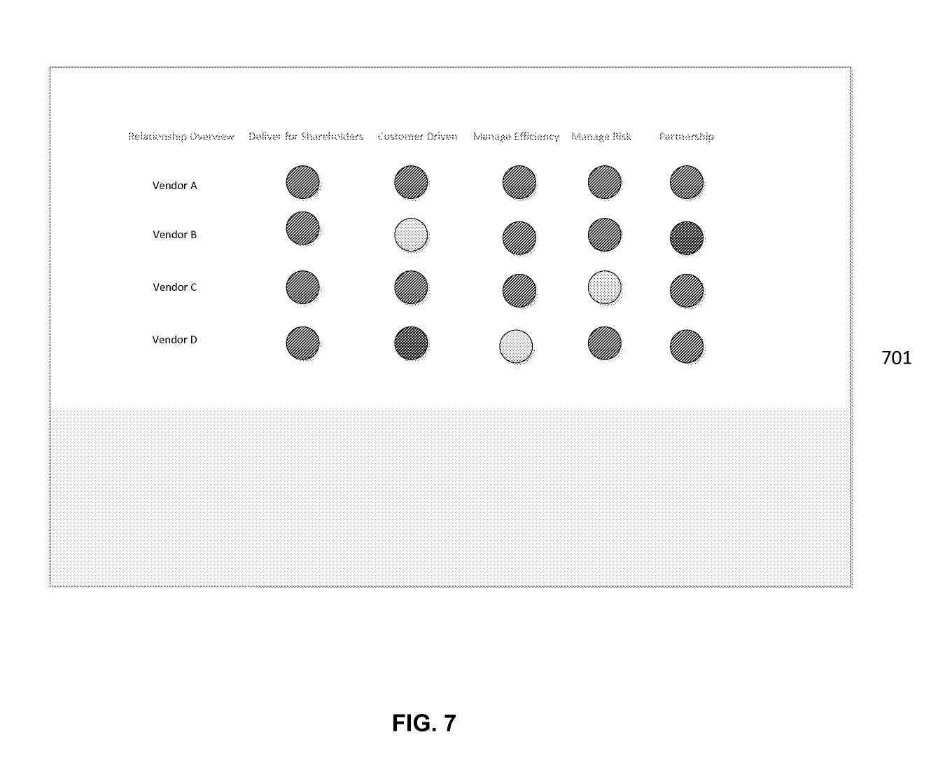

After step 307, processor 103 may transmit the deal score and executive summary at step 309. In some aspects, the deal score and executive summary may be transmitted via communication link 202 from the competitive analysis firm to the enterprise, such as Bank A. The enterprise may comprise a server such as enhanced computing server 101. The deal score and executive summary may be stored at the enterprise at memory 115. In certain aspects, the enterprise's enhanced computing server 101 may be accessible via the Internet or via a website. The website may provide information similar to enterprise screen 701, shown in FIG. 7. Enterprise screen 701 may comprise a plurality of color coded indications of vendor characteristics with respect to the enterprise. For example, screen 701 may be accessible via Bank A's website (in some instances, only to authorized users of Bank A's website). Enterprise screen 701 may comprise one or more vendors, such as technology Vendors A-D. Enterprise screen 701 may also comprise one or more characteristics, such as deliver for shareholders, customer driven, manage efficiency, manage risk, partnership, and the like. A color coded indication may be provided for each vendor corresponding with each characteristic.

For example, enterprise screen 701 may indicate that Vendor D is best in class with respect to delivering for Bank A Shareholders; Vendor D needs improvement with respect to being customer driven for Bank A; and Vendor D is average with respect to managing efficiency for Bank A. Each color coded indication shown in enterprise screen 701 may be associated with an underlying numerical score stored at database 121. As should be understood, enterprise screen 701 is merely exemplary and may include other variations of vendors and characteristics.

The foregoing descriptions of the disclosure have been presented for purposes of illustration and description. They are not exhaustive and do not limit the disclosure to the precise form disclosed. Modifications and variations are possible in light of the above teachings or may be acquired from practicing of the disclosure. For example, the described implementation includes software by the present disclosure may be implemented as a combination of hardware and software or in hardware alone. Additionally, although aspects of the present disclosure are described as being stored in memory, one skilled in the art will appreciate that these aspects can also be stored on other types of computer-readable media, such as secondary storage devices, like hard disks, floppy disks, or CD-ROM.

What is claimed is:

1. A method, comprising:
receiving, at a processor, a key indicator, a scoring mechanism, and an executive summary template;
receiving, at a processor, a negotiated deal, wherein the negotiated deal includes terms of the negotiated deal;
calculating, at the processor, a deal score for the negotiated deal, wherein the deal score is calculated using the key indicator and the scoring mechanism;
generating, at the processor, an executive summary, wherein the executive summary is generated using the executive summary template; and
transmitting, at the processor, the deal score and the executive summary.

2. The method of claim 1, wherein the negotiated deal comprises terms of a deal that were negotiated using a combination of internal analysis and external analysis.

3. The method of claim 2, wherein the external analysis comprises at least one of Level 1 external analysis, Level 2 external analysis, and Level 3 external analysis.

4. The method of claim 1, wherein the deal score comprises a deal overall score and a deal components score.

5. The method of claim 4, wherein the deal components score comprises an indication of each configuration's negotiated deal score as compared with peers and the market, and an indication of which direction each configuration's deal score is trending.

6. The method of claim 1, wherein the deal score is calculated based on headline discounts, concessions, vendor history, product type, quantities purchased, negotiation leverage, and deal flexibility.

7. The method of claim 1, wherein the deal score is color coded.

8. A non-transitory computer-readable storage medium having computer-executable program instructions stored thereon that, when executed by a processor, cause the processor to:
receive a key indicator, a scoring mechanism, and an executive summary template;
receive a negotiated deal, wherein the negotiated deal includes terms of the negotiated deal;
calculate a deal score for the negotiated deal, wherein the deal score is calculated using the key indicator and the scoring mechanism;
generate an executive summary, wherein the executive summary is generated using the executive summary template; and
transmit the deal score and the executive summary.

9. The non-transitory computer-readable storage medium of claim 8, wherein the negotiated deal comprises terms of a deal that were negotiated using a combination of internal analysis and external analysis.

10. The transitory computer-readable storage medium of claim 9, wherein the external analysis comprises at least one of Level 1 external analysis, Level 2 external analysis, and Level 3 external analysis.

11. The transitory computer-readable storage medium of claim 8, wherein the deal score comprises a deal overall score and a deal components score.

12. The transitory computer-readable storage medium of claim 11, wherein the deal components score comprises an indication of each configuration's negotiated deal score as compared with peers and the market, and an indication of which direction each configuration's deal score is trending.

13. The transitory computer-readable storage medium of claim 8, wherein the deal score is calculated based on headline discounts, concessions, vendor history, product type, quantities purchased, negotiation leverage, and deal flexibility.

14. An apparatus comprising:
a memory;
a processor, wherein the processor executes computer-executable program instructions which cause the processor to:
receive a key indicator, a scoring mechanism, and an executive summary template;
receive a negotiated deal, wherein the negotiated deal includes terms of the negotiated deal;
calculate a deal score for the negotiated deal, wherein the deal score is calculated using the key indicator and the scoring mechanism;
generate an executive summary, wherein the executive summary is generated using the executive summary template; and
transmit the deal score and the executive summary.

15. The apparatus of claim 14, wherein the negotiated deal comprises terms of a deal that were negotiated using a combination of internal analysis and external analysis.

16. The apparatus of claim 15, wherein the external analysis comprises at least one of Level 1 external analysis, Level 2 external analysis, and Level 3 external analysis.

17. The apparatus of claim 14, wherein the deal score comprises a deal overall score and a deal components score.

18. The apparatus of claim 17, wherein the deal components score comprises an indication of each configuration's negotiated deal score as compared with peers and the market, and an indication of which direction each configuration's deal score is trending.

19. The apparatus of claim 15, wherein the deal score is calculated based on headline discounts, concessions, vendor history, product type, quantities purchased, negotiation leverage, and deal flexibility.

20. The apparatus of claim 14, wherein the deal score is color coded.
